(19) United States
(12) Patent Application Publication
(10) Pub. No.: US 2024/0321135 A1
(43) Pub. Date: Sep. 26, 2024

(54) SET OF THREE-DIMENSIONAL HAND-HELD ELEMENTS FOR GUIDED EXPLORATION OF SOLUTIONS TO PROBLEMS

(71) Applicant: Massachusetts Institute of Technology, Cambridge, MA (US)

(72) Inventors: Joseph Coughlin, Sudbury, MA (US); Sheng-Hung Lee, Cambridge, MA (US)

(21) Appl. No.: 18/186,921

(22) Filed: Mar. 20, 2023

(51) Int. Cl. G09B 19/00

(52) U.S. Cl. CPC G09B 19/00

(57) ABSTRACT

An article of manufacture includes a set of three-dimensional elements, each having has a same size and the same shape, with at least three distinct faces on which content is provided. A first face on an element is a title page or a title face with text. The text represents certain hierarchical subject matter including a topic within a category. A second face is an icon page or an icon face with an icon, such as a graphic or line drawing. By being general, the icon provokes imagination beyond the topic expressed by the text. A third face is an image page or an image face with a photorealistic image of a scene, which may be a photographic image or computer-generated. On any given element, both the subject matter represented by the respective icon on that element and the subject matter represented by the respective image on that element are relevant to the topic represented by the respective text on that element.

### BACKGROUND

Researchers have observed the inherent challenge of envisioning our future self, particularly a future self that is older and may be in poor health, requiring care, or facing other complex issues. Retirement planning is primarily conducted to ensure financial security in older age, but it is assumed that people, and those who advise them, integrate into their planning the wide variety of conditions and events that people may face in older age. While financial professionals, employers, and retirement planners ask their clients about their ‘goals’ in retirement, their methods often meet with mixed or very limited results.

Conversations and checklists are typically used by professionals to prompt clients to articulate their goals in older age, in effect, asking clients to envision their ‘future self.’ Client responses are frequently incomplete and only identify popular images of retirement, e.g., vacation travel, grandchildren, but neglect other foreseeable critical challenges in older age, such as questions of where to live, how to spend their time, how to provide care, and other complex questions. While many service providers in the financial planning industry typically use checklists, questionnaires, online slide bar applications, and even modified playing cards, to discuss issues in retirement, none of these have been seen as universally effective in client engagement.

Compounding the problem is the view clients may have of the roles of retirement planners and financial advisors. These professionals are most often seen as only being able to assist with issues of financial security. Unfortunately, there is currently no other profession that tees up the possibilities and perils of older age. As a result, the many life events that may be experienced in older age are never articulated, anticipated, nor effectively prepared for.

Such difficulties in visualizing future conditions or problems, and provoking thinking about possible solutions can arise in many contexts other than retirement planning. Conventional conversations or checklists typically are inadequate to prompt individuals into more robust and complete thinking patterns for addressing complex subjects relating to future problems.

### SUMMARY

This Summary introduces a selection of concepts in simplified form that are described further below in the Detailed Description. This Summary neither identifies key or essential features, nor limits the scope, of the claimed subject matter.

The use of objects or artifacts may focus people's attention and provoke thinking, exploration, learning, feelings, and discussions that people may not necessarily achieve with typical formal conversations and checklists alone. To this end, a set of three-dimensional hand-held elements on which content is provided provokes individuals into thinking differently about possible solutions that can arise for their problems. Such objects can be part of a larger family of objects and a related process.

In the context of retirement planning, such a set of objects makes envisioning lives in older age more tangible. The objects are designed to organize questions and related issues in a playful and provocative way while engaging users to physically feel the issues at hand and to rhetorically build their longevity plan. The objects can be part of an overall longevity planning tool kit that includes instructions on how to arrange the set of objects, how to introduce each question or image presented on the objects into a deeper discussion, and follow up questions to help people envision their future self or life in retirement intuitively. These objects and instructions effectively engage or even gamify an otherwise ambiguous process, such as retirement planning.

A planning kit can include a combination of the set of objects and the instructions on how to use them, such as an initial setup of the plurality of blocks including at least grouping or stacking of the blocks, similar to instructions for a board game. For example, the instructions can describe placement of blocks, initial explanation of the blocks and the desired outcomes, use of entire set versus sections of the blocks, use with a client, with a client couple, or with client and adult children, translation of discussion findings into planning and preparation documents, or revisiting of the block exercise, or any combination of these. Both online and paper tools can be provided for a financial professional, or a client, or other advisors, or combinations of these, to capture responses. Such tools also allow participants to compare their thoughts and overall level of agreement on future plans and goals. Ultimately, a database can collect responses by users so to allow an individual to compare their responses with ‘other people like me.’

Accordingly, in one aspect, an article of manufacture includes a set of three-dimensional elements, each having has a same size and a same shape, with at least three distinct faces on which content is provided. A first face on an element is a title page or a title face with text. The text represents certain hierarchical subject matter including a topic within a category. The topic can be one or more provocative questions or keywords related to the category. A second face is an icon page or an icon face with an icon, such as a graphic or line drawing. By being general, the icon provokes imagination beyond the topic expressed by the text. A third face is an image page or an image face with a photorealistic image of a scene, which may be a photographic image or computer-generated. This image provokes imagination based on a specific scene related to a topic. On any given element, both the subject matter represented by the respective icon on that element and the subject matter represented by the respective image on that element are relevant to topic represented by the respective text on that element.

In another aspect, one application of such an article of manufacture is to provide a tactile, provocative, hand-held tool as part of a financial planning toolkit.

In another aspect, computer-readable storage includes computer-program instructions that, when processed by a processing device, instruct a computer to configure a mechanical device to create the article of manufacture described herein.

In some implementations, a computer system can be provided which collects information from users of such a planning kit. The information can include data about the users and data representing the responses recorded from those users, according to the categories and topics one the blocks which prompted those responses. Using such a database, a computer program can identify similar users, whether based on information about the users, or based on the responses recorded for the users, or both.

In one aspect, an article of manufacture includes first three-dimensional element having a size and a shape and a first color, the first three-dimensional element having a first color corresponding to a first category and having at least a first face, a second face, and a third face and having first text on the first face relevant to a first topic in a first category. Some embodiments may also include a first icon on the second face relevant to the first topic in the first category. Some embodiments may also include a first image on the third face relevant to the first topic in the first category.

Some embodiments may also include a second three-dimensional element having the size and the shape, the second three-dimensional element having the first color corresponding to the first category and having at least a first face, a second face, and a third face and having second text on the first face relevant to a second topic in the first category. Some embodiments may also include a second icon on the second face relevant to the second topic in the first category. Some embodiments may also include a second image on the third face relevant to the second topic in the first category.

Some embodiments may also include a third three-dimensional element having the size and the shape, the third three-dimensional element having a second color corresponding to a second category and having at least a first face, a second face, and a third face and having third text on the first face relevant to a first topic in the second category. Some embodiments may also include a third icon on the second face relevant to the first topic in the second category. Some embodiments may also include a third image on the third face relevant to the first topic in the second category.

Some embodiments may also include a fourth three-dimensional element having the size and the shape, the fourth three-dimensional element having the second color corresponding to the second category and having at least a first face, a second face, and a third face and having fourth text on the first face relevant to a second topic in the second category. Some embodiments may also include a fourth icon on the second face relevant to the second topic in the second category. Some embodiments may also include a fourth image on the third face relevant to the second topic in the second category.

Various features of the elements are selected for both aesthetics and functionality. For example, the color, material, and finishing of the elements should be selected to make the elements aesthetically pleasing to entice and engage the user's attention. Each block should have sufficient weight to communicate to the user's subconscious the importance or ‘gravity of the issue’ at hand, suggesting the blocks are not toys, but tools; however, the blocks should not be too heavy so as to speed the user's desire to put the block down and shorten a possible discussion prompted by the process. The elements should be smooth to the touch and should rest easily in a single hand of the user, while allowing the user to grasp, hold, move, play with, or otherwise manipulate the element. Thus, the volume, size, and density are related factors to have an element that fits in an individual's hand and has a suitable weight.

In one implementation for longevity planning, the set of three-dimensional elements includes a set of 14 cubes of equal size (6 cm×6 cm×6 cm). Blocks are in either red or white. Three sides of each block include one of the following: 1) a retirement question, e.g., ‘Who will you have lunch with?’ 2) an edited photo eliciting emotion around potentially eating alone in older age; 3) a graphic drawn to serve as a visual shorthand for the question, e.g., a spoon/fork. The three other sides of each cube can be left blank. The top and bottom blocks can be blank since these faces may be covered by other blocks when the blocks are stacked.

Any of the foregoing aspects or embodiment or implementations can have one or more of the following features. The shape of each element is a block which is substantially cube-like. The shape of each block has rounded edges and corners. The size of each block is approximately six centimeters along each edge.

The following Detailed Description references the accompanying drawings which form a part of this application, and which show, by way of illustration, specific example implementations. Other implementations may be made without departing from the scope of the disclosure.

### BRIEF DESCRIPTION OF THE DRAWINGS

FIG. 1 is an illustrative schematic diagram of a set of three-dimensional elements;

FIG. 2 is an example illustration of a table of content illustrating relationships among faces on a block and relationships among blocks.

FIG. 3 is a front view of a three-dimensional element.

FIG. 4 is a top view of a three-dimensional element.

FIG. 5 is a bottom view of a three-dimensional element.

FIG. 6 is a back view of a three-dimensional element.

FIG. 7 is a left view of a three-dimensional element.

FIG. 8 is a right view of a three-dimensional element.

FIG. 9 is a first perspective view illustrating a relationship between the top, left, and front sides.

FIG. 10 is a second perspective view illustrating a relationship between the top, front, and right sides.

FIG. 11 is an illustration of a geometric net for a three-dimensional element.

FIGS. 12-25 are illustrations of example combinations of different texts, icons, and images, in different categories.

### DETAILED DESCRIPTION

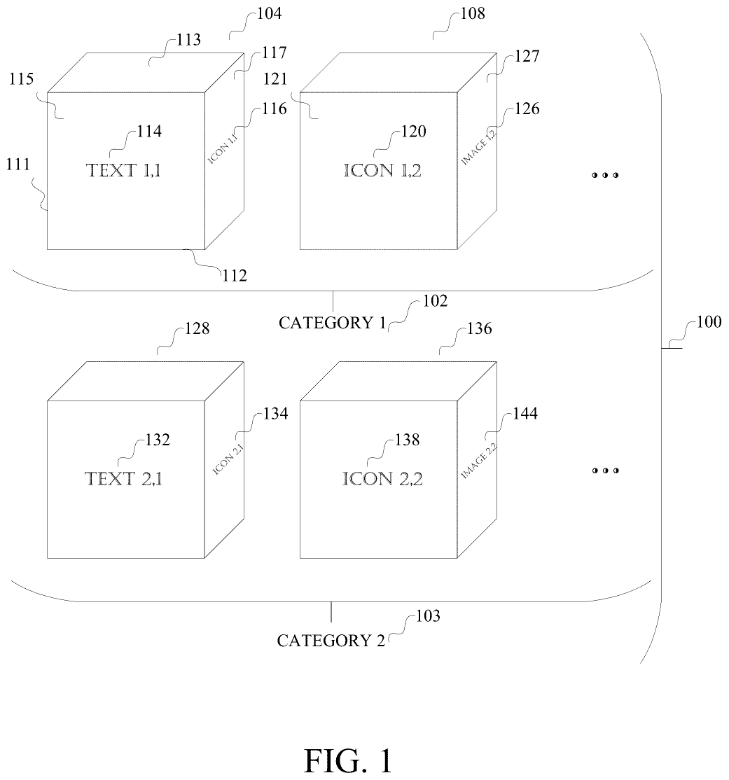

FIG. 1 is an illustrative schematic diagram of an example implementation of a set of three-dimensional elements. In some embodiments, the set of three-dimensional elements 100 may include a first subset 102 of three-dimensional elements and a second subset 103 of three-dimensional elements. The first subset is intended to present topics related to a first category (“Category 1”); the second subset is intended to present topics related to a second category (“Category 2”).

In the first subset 102 of three-dimensional elements, a first three-dimensional element 104 includes first text 114 on the first face 115 relevant to a first topic in the first category, and a first icon 116 on the second face 117 relevant to the first topic in the first category. Element 104 also has a first image on a third face (not visible, as it is on a back face in FIG. 1) relevant to the first topic in the first category. The left and bottom faces (pointed to by 111 and 112 respectively) also are not visible in FIG. 1. These faces, and the top face 113, may be left blank. In some embodiments, other content, such as branding, may appear on one or more of these faces 111, 112, and 113 of element 104.

In the first subset 102, there also is at least one more element. FIG. 1 illustrates a second three-dimensional element 108, which includes second text on a first face (not visible, as it is on the left face in FIG. 1) relevant to a second topic in the first category, a second icon 120 on a second face 121 relevant to the second topic in the first category, and a second image 126 on the third face 127 relevant to the second topic in the first category. The back and bottom faces of element 108 are not visible in FIG. 1. These back and bottom faces of element 108, and the top face, may be left blank. In some embodiments, other content, such as branding, may appear on one or more of these back, bottom, or top faces of element 108.

In the second subset 103, there also are at least two elements. FIG. 1 illustrates a third three-dimensional element 128, which includes third text 132 on the first face relevant to a first topic in the second category, a third icon 134 on the second face relevant to the first topic in the second category, and a third image on the third face (not visible on FIG. 1, as it is on the back face) relevant to the first topic in the second category. Similar to element 104, the left, bottom, and top faces of element 128 can be blank or may include other content, such as branding.

FIG. 1 also illustrates a fourth three-dimensional element 136, which includes fourth text on the first face (not visible as it is on the left face in FIG. 1) relevant to a second topic in the second category, a fourth icon 138 on the second face relevant to the second topic in the second category, and a fourth image 144 on the third face relevant to the second topic in the second category. Similar to element 108, the back, bottom, and top faces of element 136 can be blank or may include other content, such as branding.

In some embodiments, all three-dimensional elements (e.g., 104, 108, 128, 136) in all subsets (e.g., category 1 and category 2), may have the same size and the same shape. In some embodiments, the elements (e.g., 104 and 108) in the first subset 102 have a first color corresponding to the first category, whereas the elements (e.g., 128 and 136) in the second subset 103 have a second color corresponding to the second category.

In some implementations, the text for the topic includes a natural language phrase comprising a plurality of words. In some implementations, the text is in the form of a natural language question. In some implementations, the text includes a keyword. In some implementations, a keyword in the text is printed with a color, font, or size different from a color, font, or size in which other words in the text are printed. In some implementations, the text for the topic for one of the blocks in a category includes a name of the category.

In some implementations, the icon for a top includes a graphic or line drawing. By being general, the icon provokes imagination beyond the topic expressed by the text.

In some implementations, the image includes a photorealistic image of a scene. The image may be a photographic image or may be computer-generated. The image should be selected to provoke imagination based on a specific scene related to the topic.

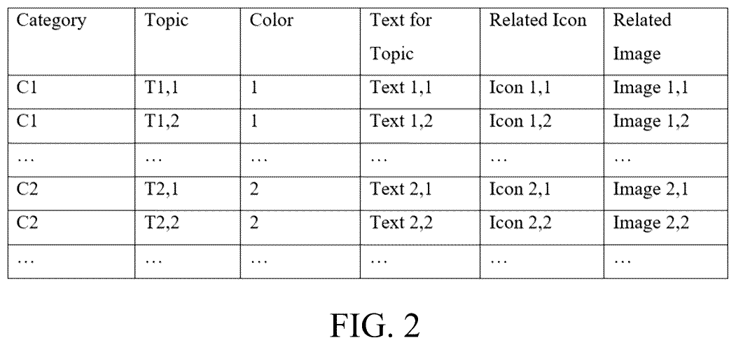

In FIG. 2, a table represents the relationships among the text, icon, and image present on the respective faces of each three-dimensional element. In this table, two distinct categories C1 and C2 are shown. There can be more than two categories (as indicated by the ellipsis in the row below C2) and the row, such as three, four, five, six, or more categories. Within each category, there can be two or more topics (as indicated by the ellipsis in each cell in the row below C1), such as three, four, five, six, or more topics. In this table, two distinct topics within each category are shown (for category C1: topics T1,1 and T1,2; for category C2: topics T2,1 and T2,2). Within each topic within a category, related text, a related icon, and a related image can be selected. Specific selections are not shown in FIG. 2; however, such specific selections can be labeled. In FIG. 2, such labeling corresponds to the labeling of the text, icons, and images shown in FIG. 1. For example, for a set of i categories, and j topics within a category, where both i and j are integers greater than or equal to 2, such labels for the text, icons, and images, can be text_{i,j}, icon_{i,j}, and image_{i,j}, respectively. Nonetheless, each category can have a different respective number of topics within the category than other categories.

In some implementations, the color, size, and font of the text is selected to permit reading by those who are visually impaired.

Such elements can be manufactured with most commonly used solid materials typically used for consumer goods and toys. In some implementations, the three-dimensional elements are manufactured using a material such as acrylic, plastic, or glass.

In some implementations, the three-dimensional elements are made with a translucent material. In some implementations, the three-dimensional elements are made with an opaque material. In implementations using a translucent material, the translucent nature of each block allows the multiple dimensions of a given topic (e.g., a question or life stage), as illustrated by the text, icon, and image, to be vaguely seen, prompting the holder to want to explore more.

In some implementations, the shape of each element is a block which is substantially cube-like. The shape of each element has rounded edges and corners. The size of each block is approximately six centimeters along each edge. Rounded corners, regardless of the shape of the element, add a pleasing feeling to the holder's hand. The object edges are smooth to the touch and palm, which comfort should result in extending the time that the user may wish to hold, look at the blocks, and describe their feelings and thoughts in response to the images and questions.

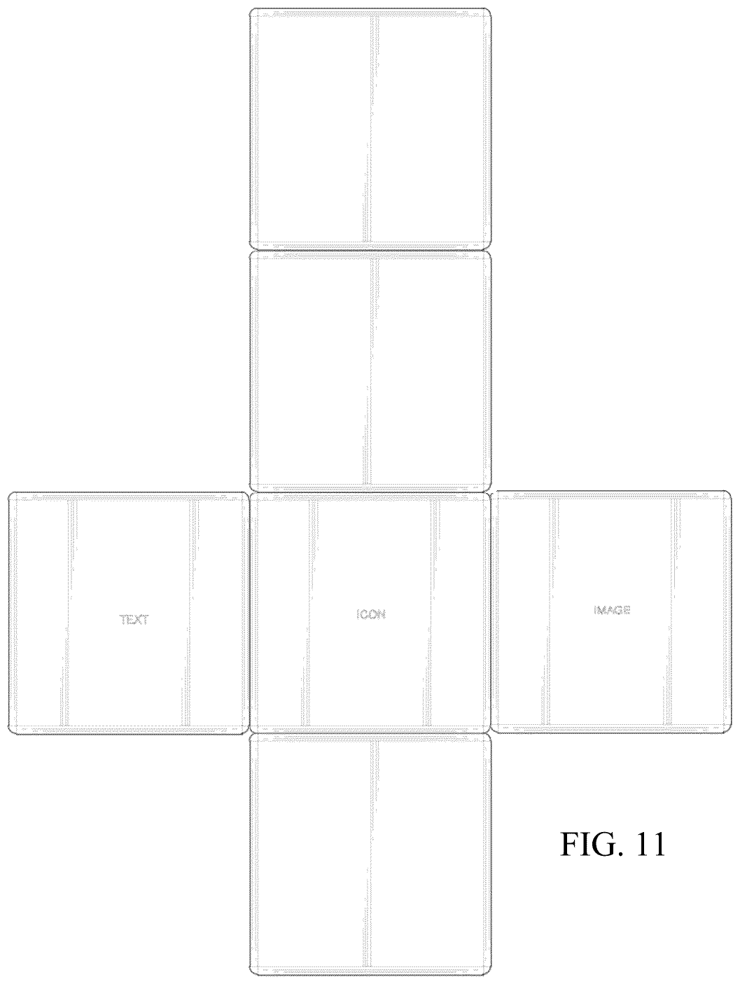

In some embodiments, the three-dimensional elements are manufactured using any material in the form of a geometrical net such as illustrated in FIG. 11. A geometrical net is a two-dimensional shape that can be folded to form a three-dimensional object. In some implementations, the geometrical net may have additional pieces of material, such as tabs, to support securing the three-dimensional object after folding. In some implementations, the geometrical net may have cuts, slots, creases, or other structural enhancements to ease folding or to assist in securing the three-dimensional object after folding. After printing content on the material in the form of the geometrical net, the geometrical net can be folded into the three-dimensional shape and secured in that shape using conventional techniques, such as adhesives. The material can be a paper product, such as cardboard.

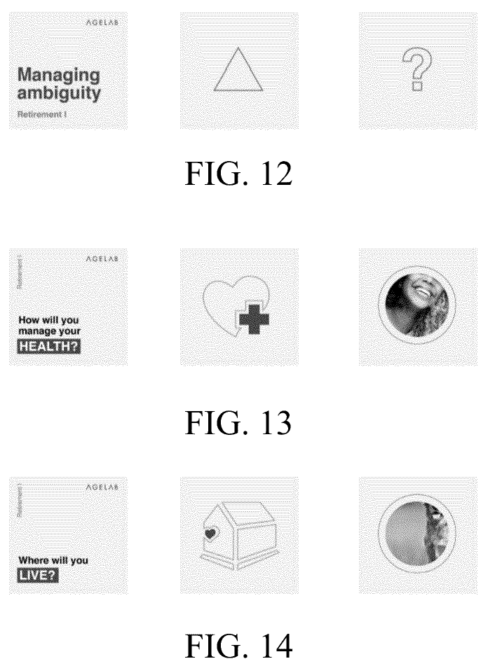

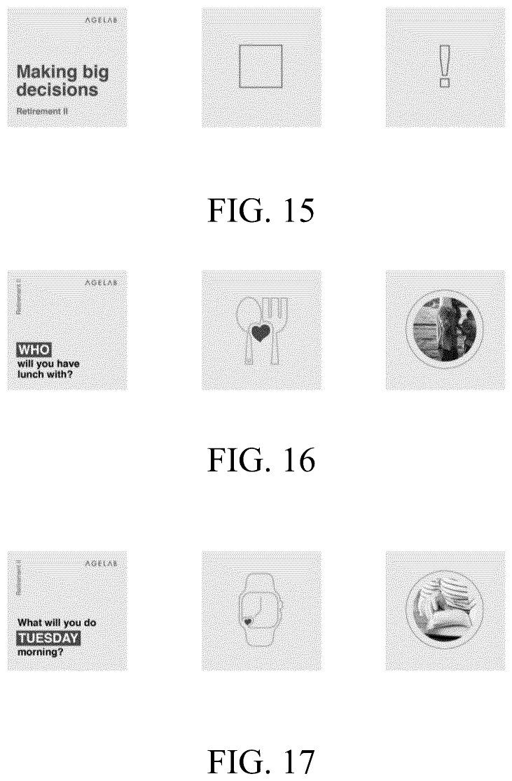

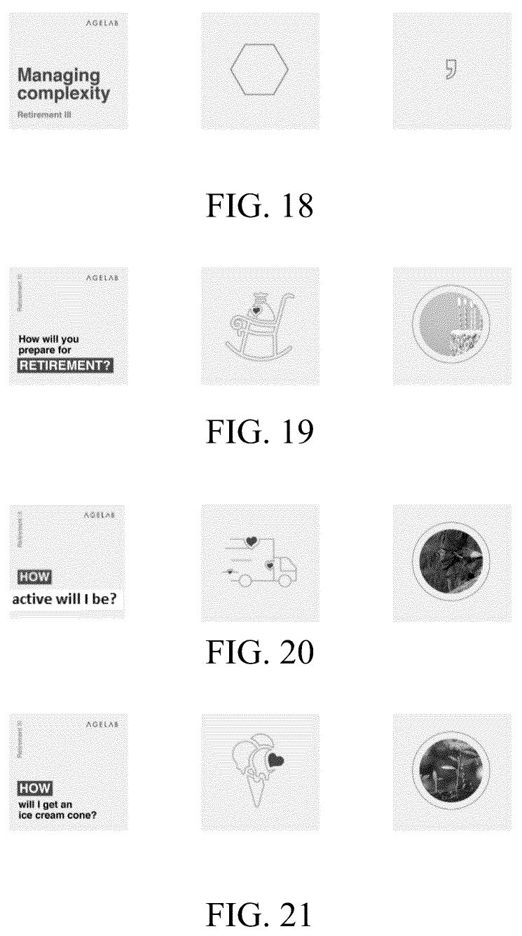

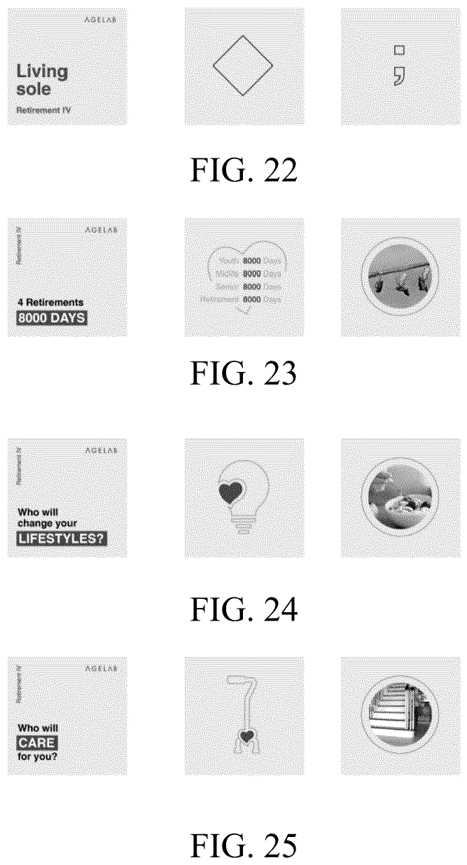

A specific example implementation of a set of fourteen (14) distinct combinations of texts, icons, and images for application to a three-dimensional element such as a cube is illustrated FIGS. 12-25. The following table (“Table I”) summarizes the content illustrated in FIGS. 12-25. In this example implementation, each category has a general name, such as “Retirement I”, and a more specific name, such as “Managing Ambiguity”. For each category, one cube for the category uses the specific name of the category as its text for the topic. Each cube in a category also can include the text of the general name for the category.

TABLE I

| Category | Text for Topic | Color | Related Icon | Related Image | FIG. |
|---|---|---|---|---|---|
| Managing | Managing Ambiguity | White | Triangle | Question mark | 12 |
| Ambiguity | | | | | |
| Managing | How will you | White | Heart with red cross | Youthful face | 13 |
| Ambiguity | manage your health? | | | | |
| Managing | Where will you | White | Home with red | Dog | 14 |
| Ambiguity | live? | | heart | | |
| Making Big | Making Big | Pink | Square | Exclamation | 15 |
| Decisions | Decisions | | | point | |
| Making Big | Who will you | Pink | Fork, spoon, | Family | 16 |
| Decisions | have lunch with? | | and red heart | | |
| Making Big | What will you do | Pink | Watch and | Person reading | 17 |
| Decisions | Tuesday | | small red heart | | |
| | morning? | | | | |
| Managing | Managing | Grey | Hexagon | Comma | 18 |
| Complexity | Complexity | | | | |
| Managing | How will you | Grey | Rocking chair | Birthday cake | 19 |
| Complexity | prepare for | | with heart and | | |
| | retirement? | | money bag | | |
| Managing | How active will I | Grey | Truck with red | Person hiking | 20 |
| Complexity | be? | | hearts | | |
| Managing | How will I get an | Grey | Ice cream cone | Seedling of a | 21 |
| Complexity | ice cream cone? | | | plant | |
| Living Soul | Living Soul | Pink | Diamond | semicolon | 22 |
| Living Soul | 8000 Days (4 | Pink | Large heart | Insects on | 23 |
| | Retirements) | | with “8000” in | plant | |
| | | | red | | |
| Living Soul | Who will change | Pink | Light bulb | Bowl of cereal | 24 |
| | your lifestyle? | | with red heart | with fruit | |
| Living Soul | Who will care | Pink | Cane with red | Staircase | 25 |
| | for you? | | heart | | |

Using the example of retirement planning, such a set of three-dimensional elements can be based on the concept of 8000 days of retirement, which is defined as four phases, with two questions being associated with each phase. The set can be called longevity planning blocks. In this example of retirement planning, the longevity planning blocks have three objectives. First, to provoke people into thinking about their future self in retirement; Second, to stimulate a structured process of conversation about current and unarticulated assumptions, needs, and possible opportunities and challenges in older age that are not directly financial in nature; and third, to help them better prepare for retirement.

In one example use case, financial professionals may arrange the blocks in their office to provoke curiosity from clients and to translate that interest into deeper conversations that lead to scenarios, fluid conversations, plans, and ultimately tangible actions, e.g., critically thinking about the implications of where they might live in retirement, improved savings behaviors. In another example use case, individuals, or couples, or families engaging adult children and parents, use the blocks at home to explore their shared, or conflicting, assumptions about their life in retirement and older age. Similar to the role of financial advisors, the blocks may set the agenda with topics that would otherwise not be envisioned or sidestepped due to their emotional or ominous impact.

Example questions an individual may have but may be hesitant or may feel embarrassed to express, include, but are not limited to: Who will care for you? Where will you live? Who will change your light bulbs? Who will you have lunch with? How will you get an ice cream cone? How will you manage your health? How will you provide care? What will you do Tuesday mornings?

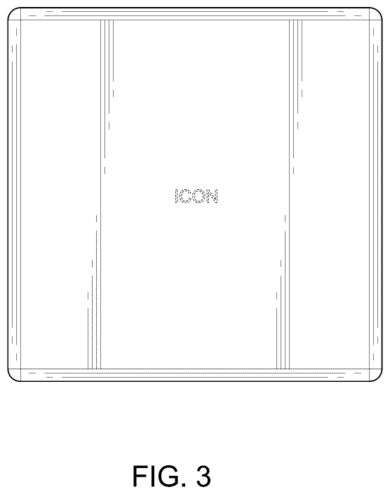

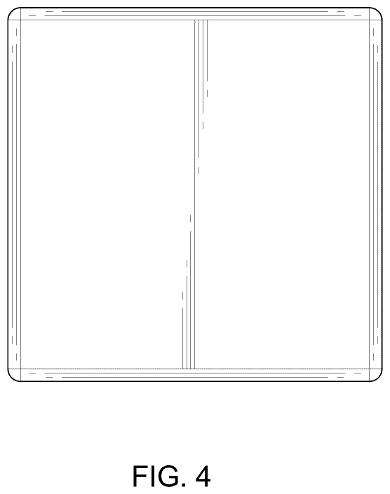

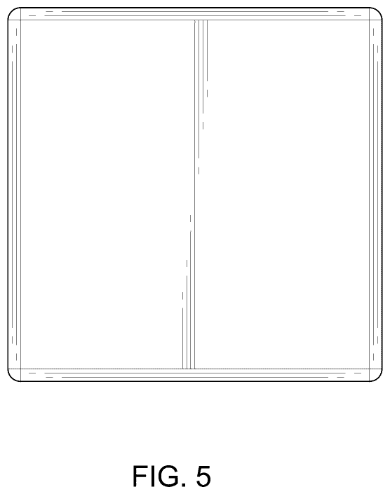

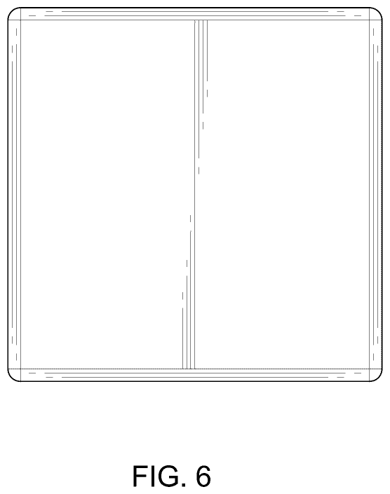

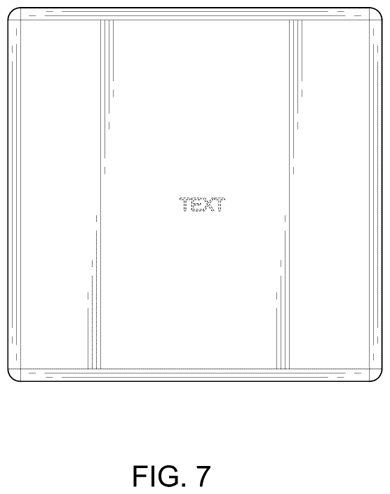

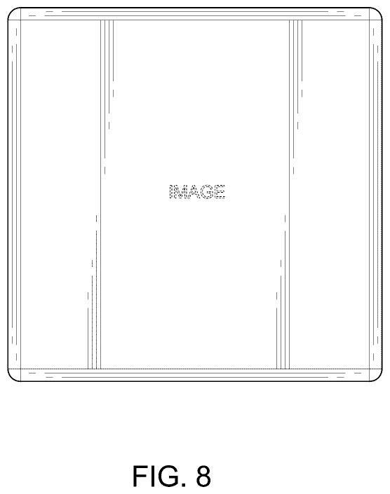

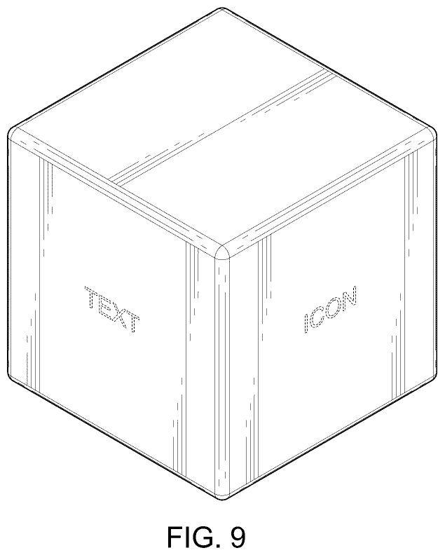

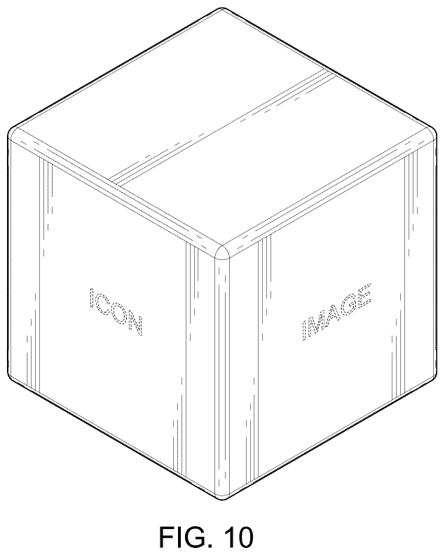

FIGS. 3-10 illustrate an ornamental design for a three-dimensional element in a set of three-dimensional elements. Any specific text, icon, or image is not illustrated, and each of the words “TEXT”, “ICON”, or “IMAGE” is presented in dash lines to indicate the present of an arbitrary text, icon, or image; however, each of the words in the drawings individually does not and collectively do not form a part of the ornamental design. In some embodiments, the ornamental design comprises a plurality of such three-dimensional elements having the same shape and size, but with distinct respective text, icons, and images on each three-dimensional element, as described in connection with FIGS. 1 and 2.

In implementations where the elements are translucent, translucence evokes a theme of transparency of trust in the process, suggestive that everything is seen and understood by the user.

The size of each element should be larger than dice, which symbolize a wager or a gamble. Longevity and financial planning or other complex problems should not be equated in anyway in the user's mind with gambling or with a ‘crap shoot.’

In some implementations, a computer system can be provided which collects information from users of such a planning kit. The information can include data about the users and data representing the responses recorded from those users, according to the categories and topics one the blocks which prompted those responses. Using such a database, a computer program can identify similar users, whether based on information about the users, or based on the responses recorded for the users, or both.

It should be understood that the subject matter defined in the appended claims is not necessarily limited to the specific implementations described above. The specific implementations described above are disclosed as examples only.

What is claimed is:

1. An article of manufacture comprising
a plurality of blocks of a same size and shape, each block including:
i. respective text on a first face indicative of a respective topic within a category;
ii. a respective photorealistic image on a second face and exemplifies the respective topic; and
iii. a respective icon on a third face representing the respective topic;
wherein the plurality of blocks includes a first set of blocks having a first color, and a second set of blocks having a second color different from the first color, wherein the respective text on the first faces of the first set of blocks are related to a first topic and the respective text on the second faces of the second set of blocks are related to a second topic distinct from the first topic.

2. The article of manufacture of claim 1, wherein the shape of each block is substantially cube-like.

3. The article of manufacture of claim 2, wherein the shape of each block has rounded edges and corners.

4. The article of manufacture of claim 3, wherein the size of each block is approximately six centimeters along each edge.

5. An article of manufacture comprising
A. a first three-dimensional element having a size and a shape and a first color, the first three-dimensional element having a first color corresponding to a first category and having at least a first face, a second face, and a third face and having:
i. first text on the first face relevant to a first topic in a first category,
ii. a first icon on the second face relevant to the first topic in the first category, and
iii. a first image on the third face relevant to the first topic in the first category;
B. a second three-dimensional element having the size and the shape, the second three-dimensional element having the first color corresponding to the first category and having at least a first face, a second face, and a third face and having:
i. second text on the first face relevant to a second topic in the first category,
ii. a second icon on the second face relevant to the second topic in the first category, and
iii. a second image on the third face relevant to the second topic in the first category;
C. a third three-dimensional element having the size and the shape, the third three-dimensional element having a second color corresponding to a second category and having at least a first face, a second face, and a third face and having:
i. third text on the first face relevant to a first topic in the second category,
ii. a third icon on the second face relevant to the first topic in the second category, and
iii. a third image on the third face relevant to the first topic in the second category; and
D. a fourth three-dimensional element having the size and the shape, the fourth three-dimensional element having the second color corresponding to the second category and having at least a first face, a second face, and a third face and having:
i. fourth text on the first face relevant to a second topic in the second category,
ii. a fourth icon on the second face relevant to the second topic in the second category, and
iii. a fourth image on the third face relevant to the second topic in the second category.

6. The article of manufacture of claim 5, wherein the shape of each block is substantially cube-like.

7. The article of manufacture of claim 6, wherein the shape of each block has rounded edges and corners.

8. The article of manufacture of claim 7, wherein the size of each block is approximately six centimeters along each edge.

9. A kit comprising:
A. a plurality of blocks of a same size and shape, each block including:
i. respective text on a first face indicative of a respective topic within a category;
ii. a respective photorealistic image on a second face and exemplifies the respective topic; and
iii. a respective icon on a third face representing the respective topic;
wherein the plurality of blocks includes a first set of blocks having a first color, and a second set of blocks having a second color different from the first color, wherein the respective text on the first faces of the first set of blocks are related to a first topic and the respective text on the second faces of the second set of blocks are related to a second topic distinct from the first topic; and
B. a set of instructions for an individual providing an initial setup of the plurality of blocks including at least grouping or stacking of the blocks.
